(19) United States
(12) Patent Application Publication
(10) Pub. No.: US 2010/0021067 A1
(43) Pub. Date: Jan. 28, 2010

(54) ABNORMAL AREA DETECTION APPARATUS AND ABNORMAL AREA DETECTION METHOD

(76) Inventors: Nobuyuki Otsu, Ibaraki (JP); Takuya Nanri, Tokyo (JP)

Correspondence Address: NIXON & VANDERHYE, PC, 901 NORTH GLEBE ROAD, 11TH FLOOR, ARLINGTON, VA, 22203, US

(21) Appl. No.: 12/304,552

(22) PCT Filed: Jun. 13, 2007
(86) PCT No.: PCT/JP2007/061871

§ 371 Date: Jun. 3, 2009

(30) Foreign Application Priority Data
Jun. 16, 2006 (JP) 167961/2006

(51) Int. Cl. G06K 9/46

(52) U.S. Cl. 382/195

(57) ABSTRACT

An abnormal area detecting apparatus is provided for detecting the presence or absence and the position of abnormality with high accuracy using higher-order local auto-correlation feature. The abnormal area detecting apparatus comprises means for extracting feature data from image data on a pixel-by-pixel basis through higher-order local auto-correlation; means for adding the feature data extracted by the feature data extracting means for pixels within a predetermined range including each of pixels spaced apart by a predetermined distance; means for calculating an index indicative of abnormality of feature data with respect to a subspace indicative of a normal area; means for determining an abnormality based on the index; and means for outputting a pixel position at which an abnormal is determined. The apparatus may extract a plurality of higher-order local auto-correlation feature data which differ in displacement width. Further, the apparatus may comprise means for finding a subspace indicative of a normal area based on a principal component vector from feature data in accordance with a principal component analysis approach. The apparatus is capable of determine an abnormality on a pixel-by-pixel basis, and capable of correctly detecting the position of an abnormal area.

### TECHNICAL FIELD

The present invention relates to an abnormal area detecting apparatus and an abnormal area detecting method for capturing an image to automatically detect an area which is different from normal areas.

### BACKGROUND ART

Conventionally, in a test of a film on, for example, a flexible wiring board for defects, a broken line can be detected through electric conduction, but a reduction in thickness of a line, which can cause a defective product, cannot be detected through electric conduction. It is therefore necessary to detect abnormalities such as reduction in thickness through visual inspection or using an image.

For the visual inspection, a visual testing apparatus or the like must be utilized for enlarging an image because lines are fines. In addition, the coordinates and degree of defects must be output in order to provide feedback of the defects to manufacturing processes. Since this involves considerable efforts, a problem arises in that difficulties are encountered in fully testing a large amount of products.

Today, an abnormality test is therefore automated using images in many product tests. A testing approach employed therefor may be a pattern matching approach which involves matching with a reference image which has been registered for each product, by way of example.

On the other hand, a variety of techniques have been proposed for detecting a particular figure or the like from image data, and determining matching/unmatching with a registered image. The following Patent Document 1, filed by the present inventors, discloses a learning adaptive image recognition/measurement system which employs higher-order local auto-correlation features (hereinafter also referred to as “HLAC data”) for two-dimensional image.

### Patent Document 1: Japanese Patent No. 2982814

Non-Patent Document 1: Juyang Weng, Yilu Zhang and Wey-Shiuan Hwang, “Candid Covariance-Free Incremental Principal component Analysis IEEE Transactions on Pattern Analysis and Machine Intelligence,” Vol. 25, No. 8, pp.1034-1040, 2003.
Non-Patent Document 2: Dorin Comaniciu and Peter Meer, Mean sift: A robust approach toward feature space analysis, IEEE Transactions on Pattern Analysis and Machine Intelligence, Vol. 24, No. 5, pp. 603-619, 2002.

### DISCLOSURE OF THE INVENTION

### Problems to be Solved by the Invention

The pattern matching approach, which is a conventional abnormal area detecting approach, has such problems as the lack of flexibility and learning effects for objects, requirements for matching position and direction, a long processing time, and a low accuracy. Also, since conductors on a flexible wiring board are made of granular resin printed on a film, a problem arises in that difficulties are experienced in detecting a figure such as an edge of a line from an image, leading to difficulties in detecting defects.

On the other hand, a learning adaptive image recognition system using the higher-order local auto-correlation feature has a problem in that it cannot be applied to defect test because it cannot locate an object (defective area) due to position invariance which provides the same detection result wherever the object (defective area) is present on an image.

It is an object of the present invention to solve the problems of the conventional examples as described above, and to provide a high-speed and general-purpose abnormal area detecting apparatus and abnormal area detecting method which are capable of detecting the presence or absence of abnormalities as well as the positions thereof with high accuracy using the higher-order local auto-correlation feature.

### Means for Solving the Problems

An abnormal area detecting apparatus of the present invention is mainly characterized by comprising feature data extracting means for extracting feature data from image data on a pixel-by-pixel basis through higher-order local auto-correlation, pixel-by-pixel feature data generating means for adding the feature data extracted by the feature data extracting means for pixels within a predetermined range including each of pixels spaced apart by a predetermined distance, index calculating means for calculating an index indicative of abnormality of feature data generated by the pixel-by-pixel feature data generating means with respect to a subspace indicative of a normal area, abnormality determining means for determining an abnormality when the index is larger than a predetermined value, and outputting means for outputting the result of the determination which declares an abnormality for a pixel position for which the abnormality determining means determines as abnormal.

Also, the abnormal area detecting apparatus is characterized in that the feature data extracting means extracts a plurality of higher-order local auto-correlation feature data which differ in displacement width. Further, the abnormal area detecting apparatus is characterize in that the index indicative of an abnormality to a subspace includes information on either a distance or an angle between feature data and the subspace.

Also, the abnormal area detecting apparatus is characterized by further comprising principal component subspace generating means for finding a subspace indicative of a normal area based on a principal component vector from feature data extracted by the feature data extracting means in accordance with a principal component analysis approach. Also, the abnormal area detecting apparatus is characterized in that the principal component subspace generating means finds a subspace based on a principal component vector in accordance with an incremental principal component analysis approach.

Also, the abnormal area detecting apparatus is characterized by further comprising classifying means for finding an index of similarity based on a canonical angle of a subspace found from pixel-by-pixel feature data generated by the pixel-by-pixel feature data generating means to the subspace, and classifying each pixel using a clustering approach, wherein the principal component subspace generating means adds the feature data on a class-by-class basis to calculate a class-by-class subspace, and the index calculating means calculates an index indicative of abnormality of the feature data generated by the pixel-by-pixel feature data generating means with respect to the class-by-class subspace.

An abnormal area detecting method of the present invention is mainly characterized by including the steps of extracting feature data from image data on a pixel-by-pixel basis through higher-order local auto-correlation, adding the feature data for pixels within a predetermined range including each of pixels spaced apart by a predetermined distance, calculating an index indicative of abnormality of the feature data with respect to a subspace indicative of a normal area, determining an abnormality when the index is larger than a predetermined value, and outputting the result of the determination which declares an abnormality for a pixel position at which an abnormality is determined.

### Advantages of the Invention

According to the present invention, effects are produced as follows.

(1) An abnormality can be determined on a pixel-by-pixel basis, and the position of an abnormal area can be correctly detected.

(2) Conventionally, the abnormality detection accuracy becomes lower if a large number of objects exist, but by appropriately selecting a predetermined area centered at a pixel, even a large number of objects under detection will not cause a lower determination accuracy for an abnormal area.

(3) Since a small amount of calculations is sufficient for feature extraction and abnormality determination, and the calculation amount is fixed irrespective of objects, fast processing can be performed.

(4) Since normal areas are statistically learned without positively defining them, it is not necessary to define what the normal area is at the stage of designing, and a detection can be made in conformity to an object under monitoring. Further, no supposition is required for an object under monitoring, and a variety of objects under monitoring can be determined to be normal or abnormal, and a high flexibility can be provided. Also, by updating a subspace of normal areas simultaneously with the abnormal determination, changes in normal areas can be followed.

(5) Even if there are a plurality of classes in objects, the objects is classified according to the position, thereby further improving the detection accuracy. Also, the classification may be previously processed, or the classification can be automatically updated simultaneously with the abnormality determination.

### BRIEF DESCRIPTION OF THE DRAWINGS

FIG. 1 is a block diagram showing the configuration of an abnormal area detecting apparatus according to the present invention.

FIG. 2 is an explanatory diagram showing an overview of abnormal area detection processing according to the present invention.

FIG. 3 is an explanatory diagram showing auto-correlation processing coordinates in a two-dimensional pixel space.

FIG. 4 is an explanatory diagram showing contents of an auto-correlation mask pattern.

FIG. 5 is a flow chart showing contents of abnormality detection processing of the present invention.

FIG. 6 is a flow chart showing contents of pixel-by-pixel HLAC data generation processing.

FIG. 7 is a flow chart showing contents of HLAC feature data generation processing.

FIG. 8 is an explanatory diagram showing the nature of a subspace of an HLAC feature.

FIG. 9 is an explanatory diagram showing an in input image and an image representative of an abnormality determination result.

### EXPLANATION OF THE REFERENCE NUMERALS

10 . . . Digital Camera

11 . . . Computer

12 . . . Monitor Device

13 . . . Keyboard

14 . . . Mouse

### BEST MODE FOR CARRYING OUT THE INVENTION

In this specification, an abnormal area is defined to be “one which is not a normal area.” Assuming that the normal area is, when considering statistical distributions of areal features, an area in which the distribution concentrates, it can be learned as a statistical distribution without a teacher. Then, the abnormal area refers to an area which largely deviates from the distribution.

As a specific approach for abnormal area detection, a subspace of normal areal features is generated within an areal feature space of higher-order local auto-correlation features, and an abnormal area is detected using the distance or angle from that subspace as an index. A principal component analysis approach, for example, is used for generating a normal area subspace, and a main component subspace is configured by main component vectors having a cumulative contribution rate of 0.99, for example.

Here, the higher-order local auto-correlation features have the nature of not requiring the extraction of an object, and exhibiting the additivity on a screen. Due to this additivity, in a configured normal area subspace, a feature vector falls within the normal area subspace irrespective of how many normal lines are present within the screen, but when even one abnormal area exists therein, the feature vector extends beyond the subspace, and can be detected as an abnormal value. Since lines need not be individually tracked and extracted, the amount of calculations is constant, not proportional to the number of lines, making it possible to perform calculations at high speeds.

Also, in the present invention, in order to detect the position of an object, for each pixel spaced away by a predetermined distance (arbitrary distance equal to or more than one pixel), HLAC data in a predetermined area including (centered at) this pixel is accumulated to find pixel-by-pixel HLAC feature data, and an abnormality determination is made using this data and the distance or angle to the normal area subspace. With this processing, each pixel can be determined to be normal/abnormal.

For extraction of a areal feature from image data, a higher-order local auto-correlation (HLAC) feature is used. A k-th component of the HLAC feature is given by the following Equation 1:

h(B_{N}^{k})=∫_{W×H}I(r)I(r+aₗ^{k}). . . I(r+a_{N}^{k})dr, B_{N}^{k}=[aₗ^{k}, . . . a_{N}^{k}] [Equation 1]

where I(r) represents an image, and a variable r (reference point) and N local displacements aₙ^{k} are a two-dimensional vector which have coordinates x, y within the screen as components. B_{N}^{k} is a local displacement matrix which has N local displacements as column components. Further, the integration range is defined in an image area of W×H, where W and H represents the width and height of the image.

Also, in the present invention, HLAC features in a wider area are also extracted, not limiting a neighboring area to 3×3. Accordingly, consider a cubic higher-order local auto-correlation feature formulated in the following manner, using a matrix R.

$$R ( {λ}_{x} , {λ}_{y} ) = [ \begin{matrix}{λ}_{x} & 0 \\ 0 & {λ}_{y}\end{matrix} ] \\ \begin{matrix}h ( {B}_{N}^{k} , R ) = \int I ( r ) I ( r + {Ra}_{1}^{k} ) … I ( r + {Ra}_{N}^{k} ) d r \\ = h ( {RB}_{N}^{k} )\end{matrix} \qquad [ Equation 2 ]$$

This feature has a feature amount proportional to a feature amount extracted from an image Iₐₘₚ(r,R)=I(Rr) which has a scale within the image plane reduced by a factor of λ_{X} in the horizontal direction and by a factor of λ_{y} in the vertical direction, with respect to an image I(r). Specifically, a CHLAC feature hₐₘₚ(Br,R) extracted for Iₐₘₚ(r,R) is given as follows:

$$\begin{matrix}{h}_{amp} ( {B}_{N}^{k} , R ) = \int {I}_{amp} ( r , R ) {I}_{amp} ( r + {a}_{1}^{k} , R ) … \\ {I}_{amp} ( r + {a}_{N}^{k} , R ) d r \\ = \int I ( Rr ) I ( R ( r + {a}_{1}^{k} ) ) … \\ I ( R ( r + {a}_{N}^{k} ) ) d r\end{matrix} \\ when {r}^{′} = Rr , \\ = \int I ( {r}^{′} ) I ( {r}^{′} + {Ra}_{1}^{k} ) … \\ I ( {r}^{′} + {Ra}_{N}^{k} ) \vert {R}^{- 1} \vert d {r}^{′} \\ = \frac{1}{{λ}_{x} {λ}_{y}} \int I ( {r}^{′} ) I ( {r}^{′} + {Ra}_{1}^{k} ) … \\ I ( {r}^{′} + {Ra}_{N}^{k} ) d {r}^{′} \\ = \frac{1}{{λ}_{x} {λ}_{y}} h ( {RB}_{N}^{k} ) \qquad [ Equation 3 ]$$

It is therefore understood that a feature amount correlated in a wider area using the matrix R is larger than an HLAC feature amount extracted from an image reduced from an original image by a factor of λ_{X}λ_{y}. Actually, when considering that correlation features as many as possible will be extracted from a certain object, the scale of an image must be appropriately changed in accordance with the object and image, where, using these parameters, the scale can be adjusted such that an intended feature can be well extracted.

Thus, in order to be robust to the scale, a feature (λ_{X}, λ_{y}) of a different scale is added to vector components, and is used as a new feature. For example, a robust feature is provided for a scale of 35×2 dimensions by combining a feature extracted at (λ_{X}, λ_{y})=(1,1) with a feature extracted at (λ_{X}, λ_{y})=(2,2).

### EMBODIMENT 1

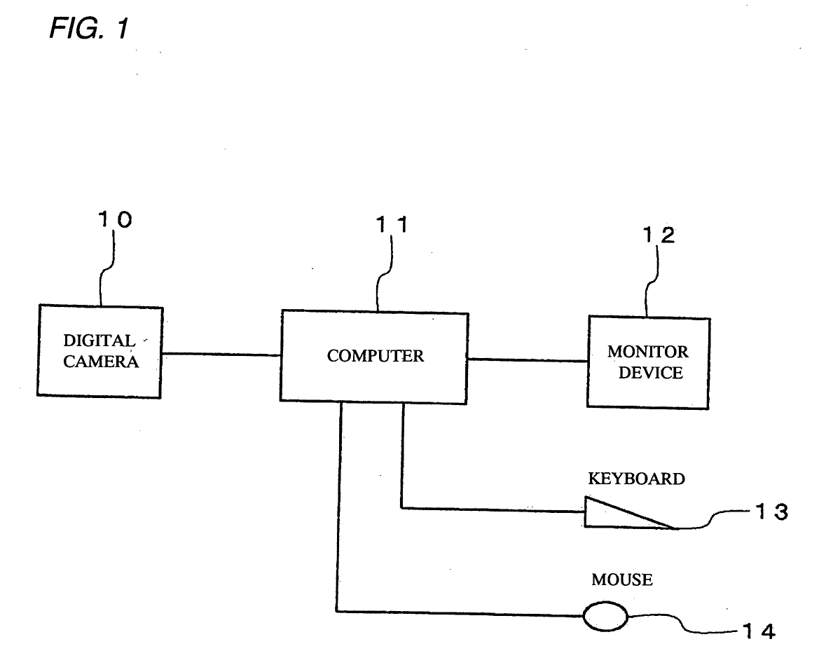

FIG. 1 is a block diagram showing the configuration of an abnormal area detecting apparatus according to the present invention. A digital camera 10 outputs image data of, for example, a product which may undergo a test. The digital camera 10 may be a camera incorporated in a microscope. Digital camera 10 may be a monochrome or a color camera. A computer 11 may be a known personal computer (PC) which is provided, for example, with an input terminal for capturing an image such as USB or the like. The present invention is implemented by creating a processing program, later described, and installing the processing program into the known arbitrary computer 11 such as a personal computer, and starting the processing program.

A monitor device 12 is a known output device of the computer 11, and is used to display to the operator, for example, that an abnormal area is detected. A keyboard 13 and a mouse 14 are known input devices used by the operator for inputting. The digital camera 10 may be connected to the computer 11 through an arbitrary communication network, or data may be transferred to the computer 11 through a memory card.

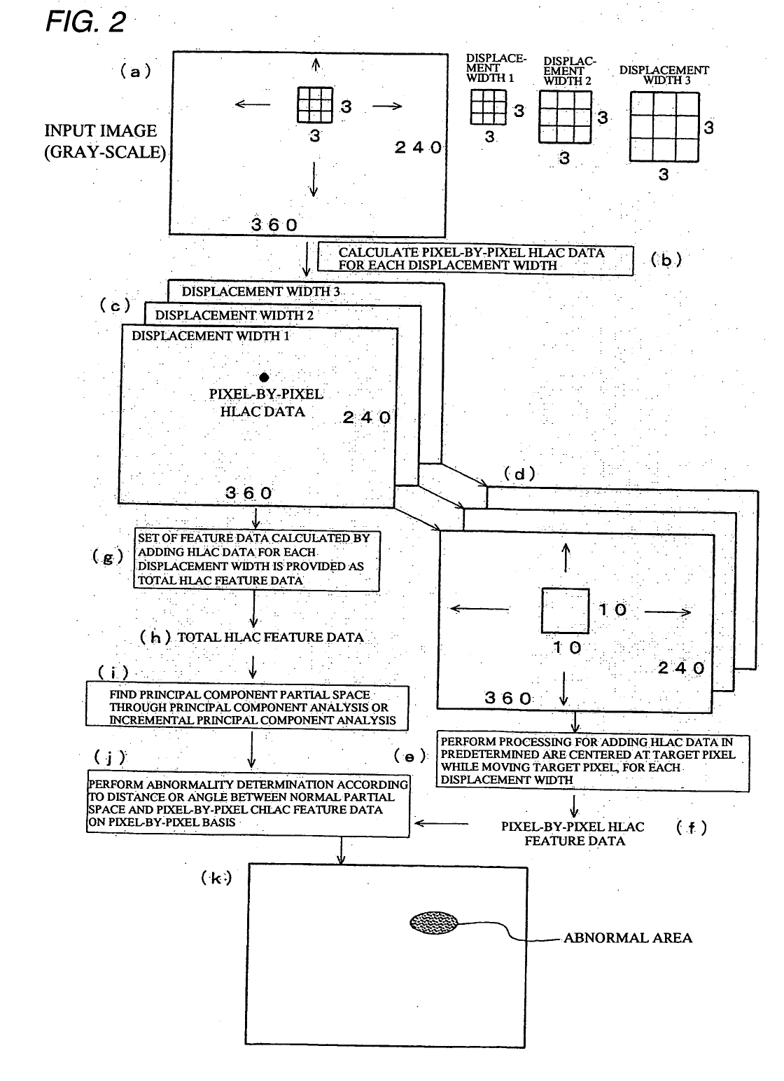

FIG. 2 is an explanatory diagram showing an overview of abnormal area detection processing according to the present invention. For example, for input image data (a) of 360×240 pixels with 256 levels of gray scale, pixel-by-pixel HLAC data is calculated on a pixel-by-pixel basis with a displacement width set to one, i.e, the displacement width equal to a pixel width (b). The HLAC data will be later described. Next, the pixel-by-pixel HLAC data is calculated on a pixel-by-pixel basis in a similar manner with the displacement width set to two, i.e., twice the pixel width (b). This processing is repeated up to a maximum value (for example, three) of the displacement width. As a result, the pixel-by-pixel HLAC data (c) is derived for each displacement width.

Next, the HLAC data (c) is added for each displacement width (g) to find a set of feature data which is designated as whole HLAC feature data (h). Then, a principal component subspace is found from the whole HLAC feature data (h) through a principal component analysis or a incremental principal component analysis (i). In general, most areas in an image are normal, so that this principal component subspace represents features of normal areas.

On the other hand, processing is performed to add HLAC data of a predetermined area (for example, 10×10) centered at a target pixel while the target pixel is moved, for each displacement width, from the pixel-by-pixel HLAC data (c) for each displacement width (e) to derive pixel-by-pixel HLAC feature data (f). Finally, an abnormality determination is made in accordance with the distance or angle between the normal subspace and the pixel-by-pixel HLAC feature data on a pixel-by-pixel basis (j), and a pixel position determined as abnormal is displayed and output as an abnormal area (k).

In this regard, in the present invention, the normal area subspace generation processing (g), (i) may be previously executed for the entire area of the image or for a randomly or regularly sampled partial area, and the abnormality determination processing (i) may be performed on the basis of resulting normal area subspace information.

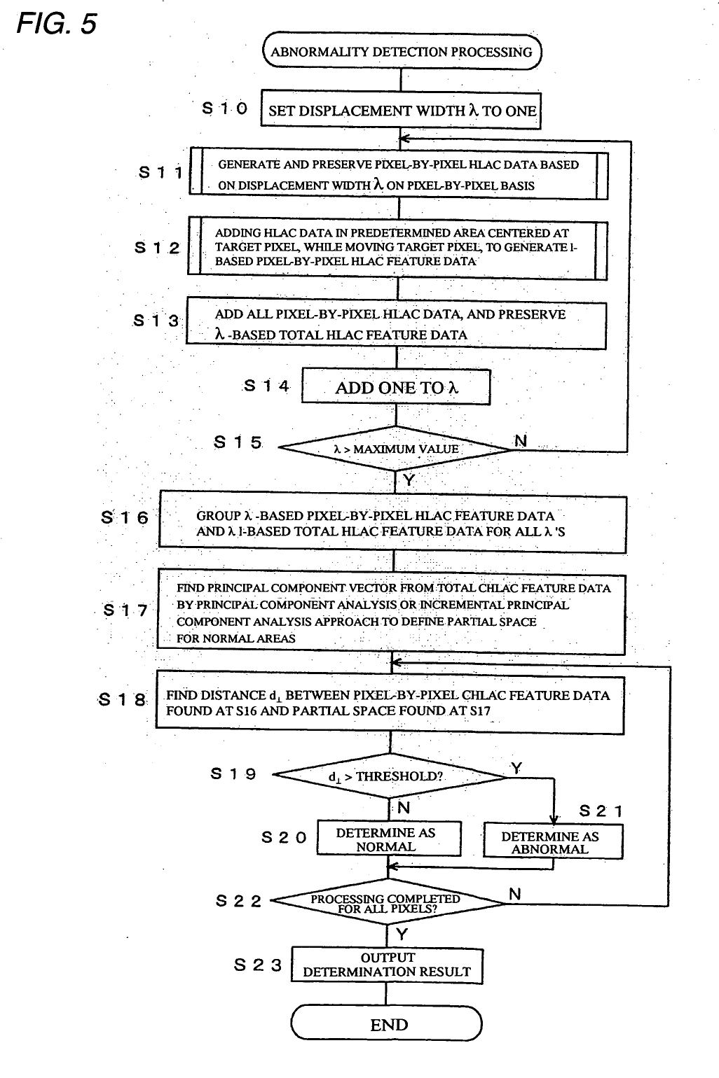

In the following, details of the processing will be described. FIG. 5 is a flow chart showing contents of the abnormality detection processing of the present invention. Assume herein that a gray scale image data of 256 levels, for example, has been previously read. At S10, a displacement width λ is set to one. At S11, image corresponding HLAC data based on the displacement width λ is generated for each pixel of the image, and is preserved. Details of this processing will be later described.

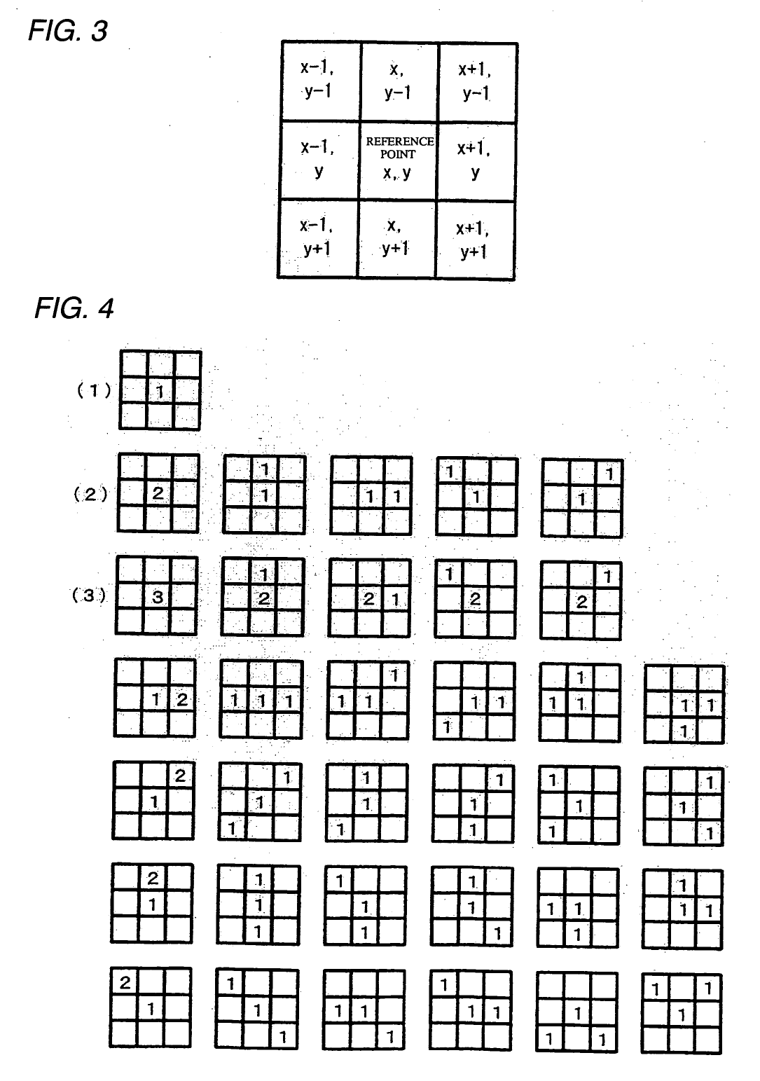

FIG. 3 is an explanatory diagram showing auto-correlation processing coordinates in a two-dimensional pixel space. The present invention correlates pixels within a square composed of 3×3 (=9) pixels centered at a target reference pixel (when λ=1). A mask pattern is information indicative of a combination of the pixels which are correlated. The target pixel at the center of the square (reference point) is selected without fail, and surroundings represent local displacements. Data on pixels selected by the mask pattern are used in calculations of correlated value.

FIG. 4 is an explanatory diagram illustrating contents of auto-correlation mask patterns. FIG. 4(1) is the simplest zero-th order mask pattern which comprises only a target pixel (one). FIG. 4(2) is an exemplary first-order mask pattern for selecting two hatched pixels (five in total), where a number within each frame indicates the number of times a pixel value associated therewith is multiplied. FIGS. 4(3) onward are exemplary third-order mask patterns (29 in total), where three pixels are selected. There are a total of 35 mask patterns for contrast images, i.e., the number of components of the HLAC feature, except for those patterns which duplicate when the target pixel is moved. In other words, there is a 35-dimensional higher-order local auto-correlation feature vector for one two-dimensional data.

At S12, HLAC data of a predetermined area centered at the target pixel, for example, a 10×10 area is added, while the target pixel is moved, to generate λ-corresponding pixel-by-pixel HLAC feature data. Details of this processing will be later described. At S13, all pixel-by-pixel HLAC data are added to preserve λ-based total HLAC feature data.

At step S14, one is added to λ. At S15, it is determined whether or not λ exceeds the highest value (for example, three). The processing transitions to SS11 when the determination result is negative, whereas the processing transitions to SS16 when the result is positive. At S16, the λ-based pixel-by-pixel HLAC feature data and λ-based total HLAC feature data are respectively grouped for all λ's. Therefore, when λ has the highest value of three, the pixel-by-pixel HLAC feature data and total HLAC feature data have 105 dimensions (=35×3).

At S17, principal vector components are found from the total HLAC feature data by a principal component analysis approach or an incremental principal component analysis approach to define a subspace for normal areas. The principal component analysis approach per se is well known, and will therefore be described in brief. First, for configuring the subspace of normal areas, principal component vectors are found from the total HLAC feature data by a principal component analysis. An M-dimensional HLAC feature vector x is expressed in the following manner:

xᵢεV^{M}(i=1, . . . ,N) [Equation 4]

where M=35. Also, the principal component vectors (eigenvectors) are arranged in a column to generate a matrix U expressed in the following manner:

U=[uₗ, . . . u_{M}],uⱼεV^{M}(j=1, . . . ,M) [Equation 5]

The matrix U which has the principal component vectors arranged in a column is derived in the following manner. An auto-correlation matrix R_{X} is expressed by the following equation:

$${R}_{X} = \frac{1}{N} {\sum }_{i = 1}^{N} \{ {x}_{1} {x}_{i}^{T} \} \qquad [ Equation 6 ]$$

The matrix U is derived from an eigenvalue problem expressed by the following equation using the auto-correlation matrix R_{X}.

R_{X}U=UΛ [Equation 7]

An eigenvalue matrix A is expressed by the following equation:

Λ=diag(λₗ, . . . ,λ_{M}) [Equation 8]

A cumulative contribution ratio αₖ up to a K-th eigenvalue is expressed in the following manner:

$${a}_{K} = \frac{{\sum }_{i = 1}^{K} {λ}_{i}}{{\sum }_{i = 1}^{M} {λ}_{i}} \qquad [ Equation 9 ]$$

Now, a space defined by eigenvectors u₁, . . . , uₖ up to a dimension in which the cumulative contribution ratio αₖ reaches a predetermined value (for example, αₖ=0.99) is applied as the subspace of normal areas. It should be noted that an optimal value for the cumulative contribution ratio αₖ is determined by an experiment or the like because it may depend on an object under monitoring and a detection accuracy. The subspace corresponding to normal areas is generated by performing the foregoing calculations.

Next, a description will be given of the incremental principal component analysis approach which incrementally finds subspaces without solving an eigenvalue problem or finding a covariance matrix. Since a large amount of data is treated in applications to the real world, it is difficult to keep all data stored. As such, subspaces of normal areas are incrementally learned and updated.

An approach considered suitable for the incremental principal component analysis may first solve an eigenvalue problem at each step. An auto-correlation matrix R_{X} required for the eigenvalue problem is updated in the following manner.

$$Rx ( n ) = \frac{n - 1}{n} Rx ( n - 1 ) + \frac{1}{n} x ( n ) {x ( n )}^{T} \qquad [ Equation 10 ]$$

where R_{X}(n) is an auto-correlation matrix at an n-th step, and x(n) is an input vector at the n-th step. Though faithful to the principal component analysis approach described above, the incremental principal component analysis has a disadvantage of a large amount of calculations because the eigenvalue problem must be solved at each step. Thus, CCIPCA is applied. This is an approach for incrementally updating an eigenvector without solving the eigenvalue problem or finding a correlation matrix. The contents of CCIPCA is disclosed in Non-Patent Document 1.

This algorithm is a very fast approach because it need not solve the eigenvalue problem at each step. Also, in this approach, while the engenvalue does not so well converge, the eigenvector characteristically converges fast. A first eigenvector and a first eigenvalue are updated in the following manner:

$$v ( n ) = \frac{n - 1}{n} v ( n - 1 ) + \frac{1}{n} x ( n ) {x ( n )}^{T} \frac{v ( n - 1 )}{‖ v ( n - 1 ) ‖} \qquad [ Equation 11 ]$$

where the eigenvector is represented by v/∥v∥, and the eigenvalue by ∥v∥. In this update rule, it has been proved that v(n)>±λ₁e₁ when n is infinite, where λ₁ is a maximum eigenvalue of the correlation matrix R of a sample, and e₁ is an eigenvector corresponding thereto. It has been shown that an n-th eigenvector and an n-th eigenvalue are gradually updated in conformity to Gram-Schmidt's orthogonarization from the first eigenvector and first eigenvalue, and converge to a true eigenvalue and eigenvector, respectively. An updating algorithm is shown below in detail.

[Equation 12]

K principal eigenvectors v1(n), . . . , vk(n) are calculated from x(n). The following processing is performed for n=1, 2, . . . :

1. u₁(n)=x(n), and

2. the following processing is performed up to i=1,2, . . . min(k,n):

(a) if i=n, an i-th vector is initialized to vᵢ(n)=uᵢ(n); and

(b) otherwise, the following processing is performed:

$${v}_{i} ( n ) = \frac{n - 1}{n} {v}_{i} ( n - 1 ) + \frac{1}{n} {u}_{i} ( n ) {u}_{i}^{T} ( n ) \frac{v ( n - 1 )}{‖ v ( n - 1 ) ‖}$$

$${u}_{i + 1} ( n ) = {u}_{i} ( n ) - {u}_{i}^{T} ( n ) \frac{{v}_{i} ( n )}{‖ {v}_{i} ( n ) ‖} \frac{{v}_{i} ( n )}{‖ {v}_{i} ( n ) ‖}$$

The present invention determines an upper limit value, rather than finding M, which is the number of all dimensions, for an eigenvector which is intended by CCIPCA to solve. While solving an eigenvalue problem involves finding engenvalues before finding a cumulative contribution ratio, and taking dimensions until the cumulative contribution ratio exceeds, for example, 0.99999, CCIPCA defines the upper limit value for the following two reasons. First, the conventional method requires a large amount of calculations. All eigenvalues must be estimated for finding the contribution ratio, and a personal computer requires a time of as long as several tens of seconds for calculations in estimating all eigenvalues even excluding a calculation time for extracting features. On the other hand, when the number of dimensions is limited to a constant value, for example, four in the foregoing calculations, a personal computer can carry out the calculations in several milliseconds.

A second reason is that the eigenvalue slowly converges in the CCIPCA approach. When the CCIPCA approach is employed for a number of data included in several thousands of frames, subspaces of normal areas will eventually have approximately 200 dimensions, from which it can be seen that they do not at all converge to four to which they should essentially converge. For these reasons, the dimension of the subspaces is defined as constant. An approximate value for this parameter can be found by once solving an eigenvalue problem for an input vector which extends over a certain time width.

At S18, the distance d⊥ is found between the pixel-by-pixel HLAC feature data calculated at S16 and the subspace calculated at S17.

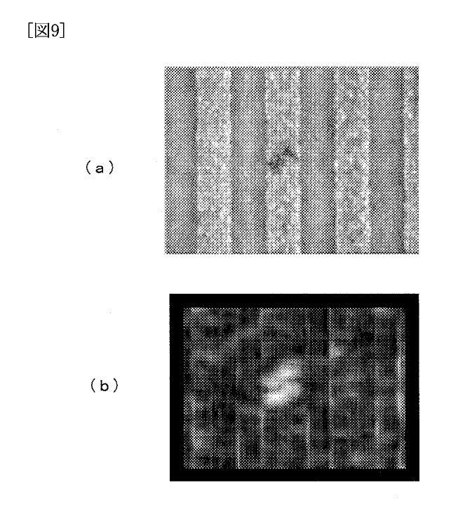

FIG. 8 is an explanatory diagram showing the nature of the subspace of the HLAC feature. For simplifying the description in FIG. 8, a HLAC feature data space is two-dimensional (26×3-dimensions in actuality), and a subspace of normal areas is one-dimensional (in embodiments, around three to twelve dimensions with a cumulative contribution ratio being set equal to 0.99, by way of example), where HLAC feature data of normal areas form groups of respective individuals under monitoring.

A normal area subspace S found by a principal component analysis exists in the vicinity in such a form that it contains HLAC feature data of normal areas. On the other hand, HLAC feature data A of an abnormal area presents a larger vertical distance d⊥ to the normal area subspace S. Accordingly, an abnormal area can be readily detected by measuring the vertical distance d⊥ between the HLAC feature data and the subspace of the normal area.

The distance d⊥ is calculated in the following manner. A projector P to the normal subspace defined by a resulting principal component orthogonal base Uₖ=[u₁, . . . , uₖ], and a projector P⊥ to an ortho-complement space to that are expressed in the following manner:

P=U_{K}U′_{K}

P_{105 =I}_{M}-P [Equation 13]

where U′ is a transposed matrix of the matrix U, and I_{M} is a M-th order unit matrix. A square distance in the ortho-complement space, i.e., a square distance d²⊥ of a perpendicular to the subspace U can be expressed in the following manner:

$$\begin{matrix}{d}_{⊥}^{2} = {‖ {P}_{⊥} x ‖}^{2} \\ = {‖ ( {I}_{M} - {U}_{K} {U}_{K}^{′} ) x ‖}^{2} \\ = {{x}^{′} ( {I}_{M} - {U}_{K} {U}_{K}^{′} )}^{′} ( {I}_{M} - {U}_{K} {U}_{K}^{′} ) x \\ = {x}^{′} ( {I}_{M} - {U}_{K} {U}_{K}^{′} ) x\end{matrix} \qquad [ Equation 14 ]$$

In this embodiment, this vertical distance d⊥ can be used as an index indicative of whether or not an area is normal. However, the aforementioned vertical distance d⊥ is an index which varies depending on the scale (norm of the feature vector). Therefore, the result of the determination can differ from one scale to another. Accordingly, another more scale robust index may be employed as shown below.

Consider first a scenario where the angle to a subspace S, i.e., sin θ is used as an index. This index, however, is not very appropriate because it presents a very large value even to a feature such as noise which has a very small scale. To cope with this inconvenience, this index is modified in the following manner such that the index presents a small value even when the scale is small:

$${d}_{⊥}^{⋀} = \frac{‖ {P}_{⊥} x ‖}{‖ x ‖ + c} \qquad [ Equation 15 ]$$

where c is a positive constant. This index corrects an abnormality determination value for the scale, so that the index works out to be robust to noise. This index means that the angle is measured from a point shifted from the origin by −c in the horizontal axis direction on the graph of FIG. 8.

At step S19, it is determined whether or not the distance d⊥ is larger than a predetermined threshold. The processing goes to S20 when the determination result is negative, whereas the processing goes to S21 when affirmative. At S20, the pixel position is determined to represent a normal area. On the other hand, at S21, the pixel position is determined to represent an abnormal area. At S22, it is determined whether or not the determination processing has been completed for all pixels. The processing goes to S18 when the determination result is negative, whereas the processing goes to S23 when affirmative. At S23, the determination result is output.

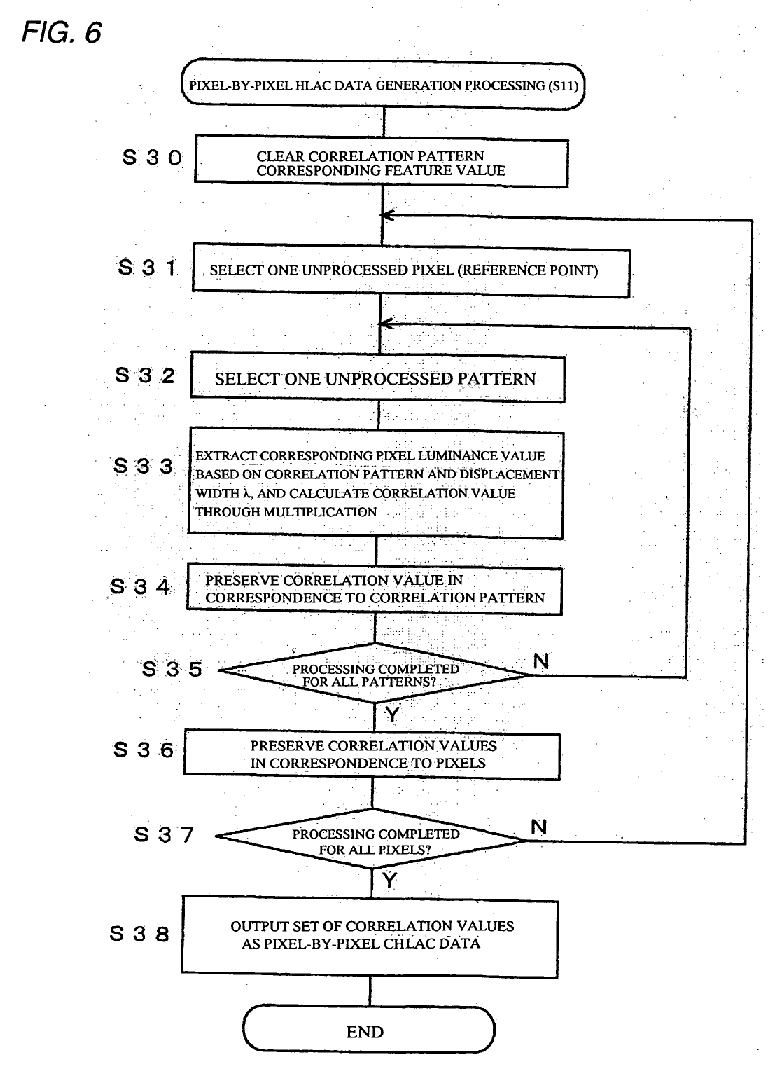

FIG. 6 is a flow chart illustrating contents of the pixel-by-pixel HLAC data generation process at S11. At S30, feature values corresponding to correlation patterns are cleared. At S31, one of unprocessed pixels (reference points) is selected. At S32, one of unprocessed patterns is selected. At S33, the correlation value is calculated using the aforementioned Equation 1, based on the correlation pattern and displacement width λ, by multiplying a pixel luminance value at a position corresponding to the pattern. Notably, this processing is comparable to the calculation of f(r)f(r+a1) . . . f(r+aN) in Equation 1.

At S34, the correlation values are preserved in correspondence to the correlation patterns. At S35, it is determined whether or not the processing has been completed for all patterns. The processing transitions to S32 when the determination result is negative, whereas the processing transitions to S36 when affirmative. At S36, the correlation values are preserved on a pixel-by-pixel basis. At S37, it is determined whether or not the processing has been completed for all pixels. The processing transitions to S31 when the determination result is negative, whereas the processing transitions to step S38 when affirmative. At S38, a set of correlation values is output as pixel-by-pixel HLAC data.

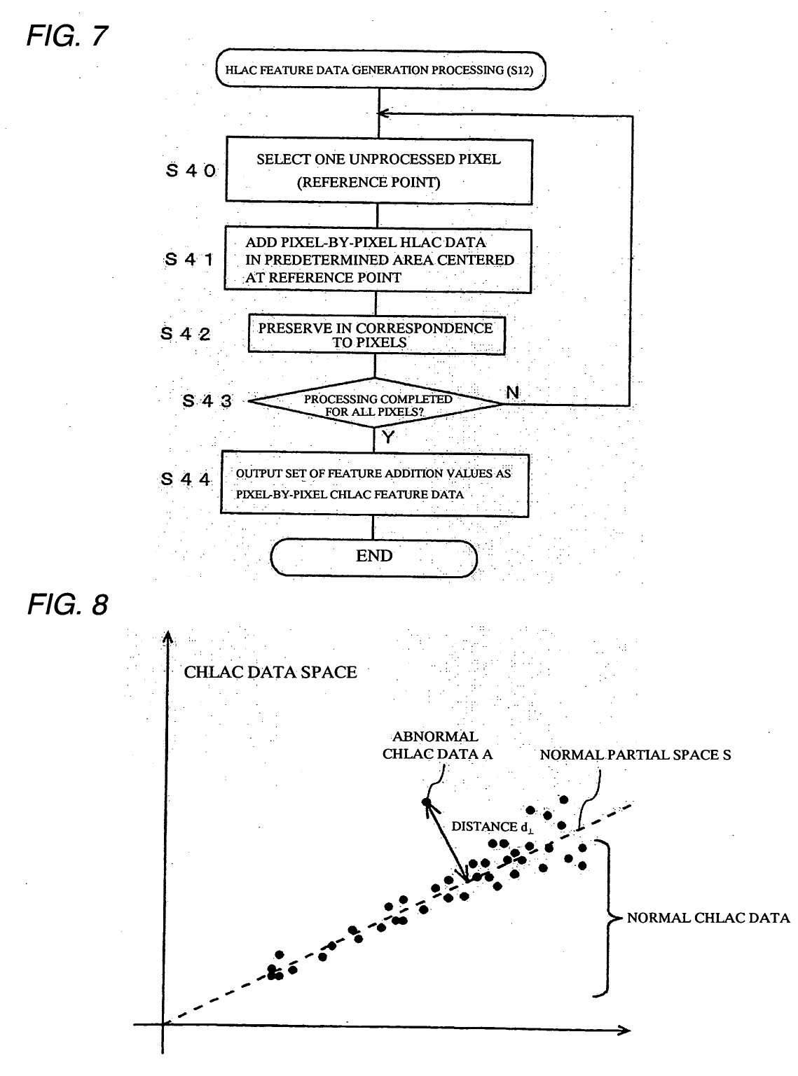

FIG. 7 is a flow chart showing contents of the HLAC feature data generation processing at S12. At S40, one of unprocessed pixels (reference points) is selected. A selecting method may involve scanning all pixels, but alternatively, may select (sample) each pixel spaced away by a predetermined distance equal to or larger than two pixels on the XY-coordinates of the image. In this way, the processing amount is reduced.

At S41, pixel-by-pixel HLAC data are added in a predetermined area centered at the reference point. The predetermined area may be, for example, in a range of 10×10 including (centered at) a target pixel. For reference, this processing is comparable to the integration in Equation 1 above which involves adding correlation values one by one (adding the correlation values on a dimension-by-dimension basis) by moving (scanning) the target pixel over a desired range.

At S42, the added data are preserved in correspondence to pixels. At step 43, it is determined whether or not the processing has been completed for all pixels. The processing transitions to S40 when the determination result is negative, whereas the processing transitions to S44 when affirmative. At S44, a set of feature added values is output as pixel-by-pixel HLAC feature data.

FIG. 9 is an explanatory diagram showing an input image and an image representative of an abnormality determination result. FIG. 9(a) represents an input contrast image, while FIG. 9(b) represents a contrast image where an abnormality index value of each pixel processed by the system of the present invention is normalized with a maximum value equal to 255 and a minimum value equal to zero. Index values in a central defective portion are larger (white), from which it can be seen that a defect has been detected.

### EMBODIMENT 2

In Embodiment 1, a subspace of normal areas is found from a whole image, whereas in Embodiment 2, when an area which includes linear line segments is mixed with an area in which a number of circular patterns exist, by way of example, the areas are classified into an area which includes linear line segments and an area in which a number of circular patterns exist, and a subspace of normal areas is found for each class to make an abnormality determination. In this way, a determination accuracy is improved.

First, principal component vectors are found from the total HLAC data and pixel-by-pixel HLAC feature data, respectively, by a principal component analysis approach or an incremental principal component analysis approach. Next, a canonical angle is calculated for the two found principal component vectors, and pixels are classified according to a similarity based on the canonical angle.

The canonical angle means the angle formed by two subspaces in the statistics, and N (=M) canonical angles can be defined between an M-dimensional subspace and an N-dimensional subspace. A second canonical angle θ₂ is a minimum angle measured in a direction orthogonal to a minimum canonical angle θ₁. Likewise, a third canonical angle θ₃ is a minimum angle measured in a direction orthogonal to θ₁ and θ₂. An F×F projection matrix is shown below:

$${P}_{1} = {\sum }_{i = 1}^{M} {Φ}_{i} {Φ}_{i}^{T} , {P}_{2} = {\sum }_{i = 1}^{N} {Ψ}_{i} {Ψ}_{i}^{T} \qquad [ Equation 16 ]$$

which is calculated from base vectors Φᵢ, Ψᵢ of subspaces L₁ and L₂ in an F-dimensional feature space.

The i-th largest eigenvalue λi of P₁P₂ or P₂P₁ is cos²θᵢ. The relationship between the M-dimensional subspace L₁ and N-dimensional subspace L₂ are completely defined by N canonical angles. When the two subspaces completely match with each other, the N canonical angles are all zero. As the two subspaces move away from each other, lower canonical angles increase, and all the canonical angles reach 90 degrees when the two subspaces are completely orthogonal to each other. In this way, a plurality of canonical angles represent a structural similarity of two subspaces. Bearing this in mind, n (=N) canonical angles are used to define a similarity S[n] in the following manner, and the defined similarity S[n] is used as an index:

$$S [ n ] = \frac{1}{n} {\sum }_{i = 1}^{n} {cos}^{2} {θ}_{i} \qquad [ Equation 17 ]$$

Next, index values found based on the similarity of the canonical angles are clustered using a Mean Shift method. The contents of the Mean Shift method are disclosed in the following Non-Patent Document 2. The Mean Shift method is a clustering approach which does not give the number of classes, and must set a scale parameter for defining the degree of vicinity. In this embodiment, since the index is the similarity of the canonical angles which simply has a value between zero and one, the scale parameter is set at approximately 0.1.

Finally, the pixel-by-pixel HLAC feature data are added on a class-by-class basis, and a principal component vector is found on a class-by-class basis from the added HLAC feature data using the principal component analysis approach or incremental principal component analysis approach as mentioned above. The resulting principal component vector represents a subspace of normal area in each class. Then, an abnormality determination is made according to the pixel-by-pixel HLAC feature data and the distance between the determined class and a corresponding subspace of normal area.

While the embodiment has been described in connection with the detection of abnormal areas, the following variations can be contemplated in the present invention. While the embodiment has disclosed an example in which abnormal areas are detected while updating the subspace of normal areas, the subspace of the normal areas may have been previously generated by a learning phase, such that a fixed subspace may be used to detect abnormal areas until the next update. Further, a small amount of data may be previously learned through random sampling or the like.

While the foregoing embodiment has disclosed an example of generating feature data on a pixel-by-pixel basis, the feature data are more similar at positions closer to each other. Accordingly, when the process illustrated in FIG. 9, for example, is performed for each of those pixels which are spaced apart from one another by a predetermined distance, a processing load can be reduced to increase the speed of operation. However, since there is a trade-off between this method and challenges such as pinpointing of location or detection accuracy, appropriate settings are required for a particular situation.

While the foregoing embodiment has disclosed an example in which a value of an integer multiple of pixels is used as λ which is a parameter for controlling the scale, an arbitrary real value including a decimal fraction can be employed for λ. However, an interpolation of pixel values is required for a real value. Alternatively, features may be extracted after an image is scaled up or down at an arbitrary scaling factor including a decimal fraction.

1. An abnormal area detecting apparatus characterized by comprising:
feature data extracting means for extracting feature data from image data on a pixel-by-pixel basis through higher-order local auto-correlation;
pixel-by-pixel feature data generating means for adding the feature data extracted by said feature data extracting means for pixels within a predetermined range including each of pixels spaced apart by a predetermined distance;
index calculating means for calculating an index indicative of abnormality of feature data generated by said pixel-by-pixel feature data generating means with respect to a subspace indicative of a normal area;
abnormality determining means for determining an abnormality when the index is larger than a predetermined value; and
outputting means for outputting the result of the determination which declares an abnormality for a pixel position for which said abnormality determining means determines an abnormal.

2. An abnormal area detecting apparatus according to claim 1, characterized in that said feature data extracting means extracts a plurality of higher-order local auto-correlation feature data which differ in displacement width.

3. An abnormal area detecting apparatus according to claim 1, characterize in that said index indicative of an abnormality to a subspace includes information on either a distance or an angle between feature data and the subspace.

4. An abnormal area detecting apparatus according to claim 1, characterized by further comprising principal component subspace generating means for finding a subspace indicative of a normal area based on a principal component vector from feature data extracted by said feature vector extracting means in accordance with a principal component analysis approach.

5. An abnormal area detecting apparatus according to claim 4, characterized in that said principal component subspace generating means finds a subspace based on a principal component vector in accordance with an incremental principal component analysis approach.

6. An abnormal area detecting apparatus according to claim 4, characterized by further comprising:
classifying means for finding an index of similarity based on a canonical angle of a subspace found from pixel-by-pixel feature data generated by said pixel-by-pixel feature data generating means to the subspace, and classifying each pixel using a clustering approach,
wherein said principal component subspace generating means adds the feature data on a class-by-class basis to calculate a class-by-class subspace, and
said index calculating means calculates an index indicative of abnormality of the feature data generated by said pixel-by-pixel feature data generating means with respect to the class-by-class subspace.

7. An abnormal area detecting method characterized by comprising the steps of:
extracting feature data from image data on a pixel-by-pixel basis through higher-order local auto-correlation;
adding the feature data for pixels within a predetermined range including each of pixels spaced apart by a predetermined distance;
calculating an index indicative of abnormality of the feature data with respect to a subspace indicative of a normal area;
determining an abnormality when the index is larger than a predetermined value; and
outputting the result of the determination which declares an abnormality for a pixel position at which an abnormality is determined.
